(19) United States
(12) Patent Application Publication
(10) Pub. No.: US 2026/0285221 A1
(43) Pub. Date: Sep. 24, 2026

(54) Caliper Mounting Golf Cart Wheel Ring

(71) Applicant: Vernon L. Walker, Converse, TX (US)

(72) Inventor: Vernon L. Walker, Converse, TX (US)

(21) Appl. No.: 19/575,568

(22) Filed: Mar. 23, 2026

Related U.S. Application Data
(60) Provisional application No. 63/775,697, filed on Mar. 21, 2025.

(51) Int. Cl. B60Q 1/26; F21S 4/00; F21W 104/00; F21Y 107/30; F21Y 115/10

(52) U.S. Cl. CPC B60Q 1/2661; F21S 4/00; F21W 2104/00; F21Y 2107/30; F21Y 2115/10

(57) ABSTRACT

A light caliper mounting system for a golf cart including a rear passenger wheel ring, a front passenger wheel ring, a front driver wheel ring, and a rear driver wheel ring. The wheel rings are bolted to the calipers of the corresponding golf cart wheels. Light strips are affixed to the wheel rings.

### CROSS-REFERENCES TO RELATED APPLICATIONS

This application claims the benefit of the filing date of provisional patent application No. 63/775,697.

### STATEMENT REGARDING FEDERALLY SPONSORED RESEARCH OR DEVELOPMENT

Not applicable.

### BACKGROUND OF THE INVENTION

### 1. Field of the Invention

The present invention relates to a device and method for affixing lights to the wheel of a golf cart by mounting a ring to the caliper of each wheel.

### 2. Description of the Related Art

It is popular for vehicle owners to install aftermarket lights on a vehicle. Typically, light emitting diode (LED) lights are used. There are various products available to configure the wiring of such lights. There remains a need for a durable and efficient way to mount LED lights to the wheels of a recreational vehicle such as a golf cart, particularly a golf cart with calipers.

### BRIEF SUMMARY OF THE INVENTION

The present invention comprises an apparatus and method for affixing lights to the caliper of each wheel of a golf cart. More specifically, the present invention relates to the affixing of lights to a golf cart having calipers such as a Venom EV golf cart. The present invention is set of rings that mount to the calipers of golf cart wheels. The present invention is specifically configured for mounting to golf cart calipers.

### BRIEF DESCRIPTION OF THE SEVERAL VIEWS OF THE DRAWINGS

FIG. 1 is a perspective view of an embodiment of a passenger side rear caliper mounting ring.

FIG. 2 is a perspective view of an embodiment of a passenger side front caliper mounting ring.

FIG. 3 is a perspective view of an embodiment of a driver side rear caliper mounting ring.

FIG. 4 is a perspective view of an embodiment of a driver side front caliper mounting ring.

FIG. 5 is a view of FIG. 1 with lights added to passenger side rear caliper mounting ring.

### DETAILED DESCRIPTION OF THE INVENTION

An embodiment of the golf cart light caliper mounting ring system is described herein. The light caliper mounting ring system comprises a passenger side rear ring 31, a passenger side front ring 32, a driver side rear ring 33, and a driver side front ring 34.

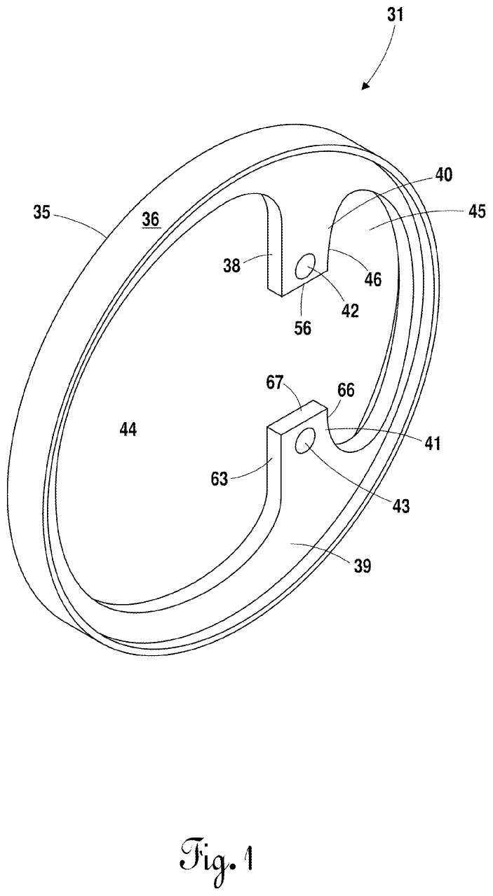

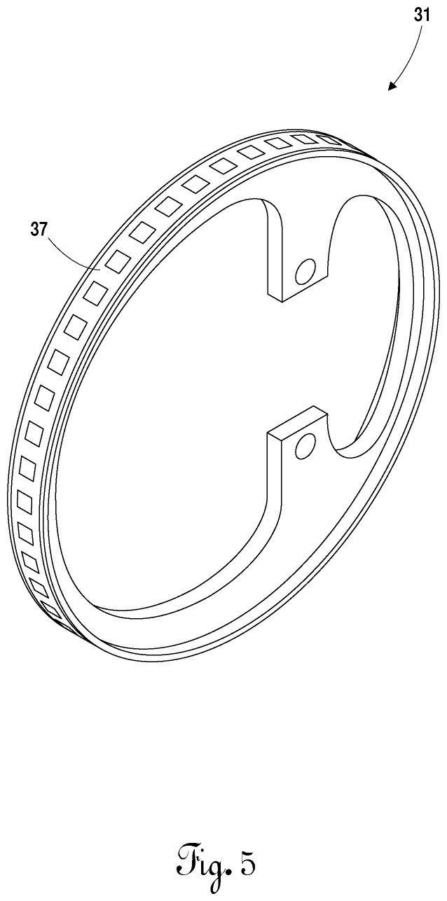

Referring to FIG. 1, the passenger rear ring 31 comprises an outer annular rim 35. The annular rim 35 is circular. The outer diameter of the annular rim is less than the inner diameter of a passenger side rear golf cart tire. The annular rim 35 comprises an outer surface 36. Referring to FIG. 5, a light strip 37 can be affixed to the outer surface 36 of the annular rim 35. The light strip 37 can be affixed to the outer surface 36 via an adhesive. In some embodiments, the light strip 37 has a peel off adhesive back that can be used to affix the light strip 37 to the outer surface 36. In some embodiments, the annular rim 35 may comprise grooves. The grooves can be used to zip-tie or otherwise tether a light strip to the outer surface 36 of the annular rim 35.

The passenger rear ring 31 further comprises a partial interior plate 39. The partial interior plate 39 comprises a first caliper mounting flange 40 and a second caliper mounting flange 41. The first caliper mounting flange 40 has a bolt hole 42 and the second caliper mounting flange 40 has a bolt hole 43. The first caliper mounting flange 40 has a first side 38, second side 46, and outer end 50. The second side 46 is slightly flared. The first side 38 is straight. The outer end 50 is straight. The other end of the first caliper mounting flange 40 is wider than the outer end 50 and is integral the partial interior plate 39. The second caliper mounting flange 41 has a first side 63, second side 66, and outer end 67. The second side 66 is slightly flared. The first side 66 is straight. The outer end 67 is straight. The other end of the second caliper mounting flange 41 is wider than the outer end 67 and integral the partial interior plate 39.

The partial interior plate 39 comprises a first opening 44 and a second opening 45. The first opening 44 and second opening 45 are partially separated by the caliper mounting flanges 40 and 41. The caliper mounting flanges 40 and 41 are closer to the one side of the ring than the other side, making the first opening 44 larger than the second opening 45.

The passenger rear ring 31 may comprise a water drainage hole along the annular rim 35.

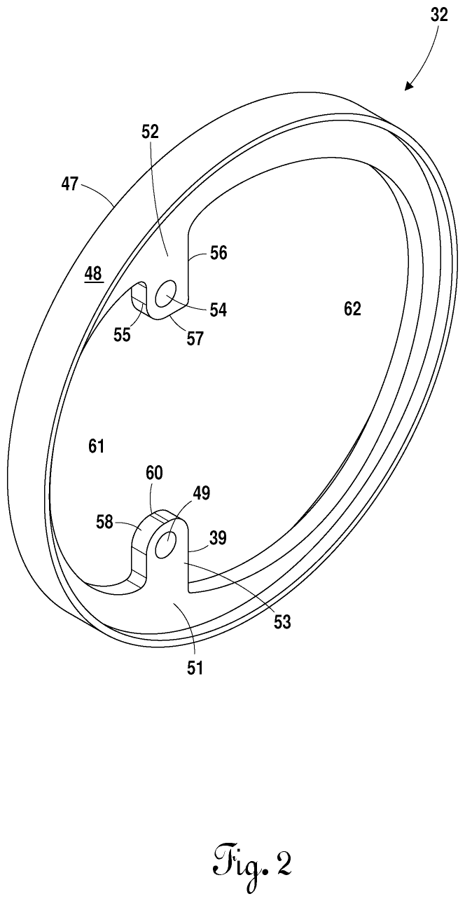

With reference to FIG. 2, the passenger front ring 32 comprises an outer annular rim 47. The annular rim 47 is circular. The outer diameter of the annular rim 47 is less than the inner diameter of a passenger side front golf cart tire. The annular rim 47 comprises an outer surface 48. A light strip 37 can be affixed to the outer surface 48 of the annular rim 47. The light strip 37 can be affixed to the outer surface 48 via an adhesive. Referring to FIG. 5, which shows a light strip 37 affixed to the outer surface of the passenger rear wheel ring 31, the light strip 37 is affixed to the passenger front ring 32 in the same manner as shown in FIG. 5 with regard to the passenger rear ring 31. In some embodiments, the light strip 37 has a peel off adhesive back that can be used to affix the light strip to the outer surface 48. In some embodiments, the annular rim 47 may comprise comprises grooves. The grooves can be used to zip-tie or otherwise tether a light strip 37 to the outer surface 48 of the annular rim 47.

The passenger front ring 32 further comprises a partial interior plate 51. The partial interior plate 51 comprises a first caliper mounting flange 52 and a second caliper mounting flange 53. The first caliper mounting flange 52 has a bolt hole 54 and the second caliper mounting flange 53 has a bolt hole 49.

The first caliper mounting flange 52 has a first side 55, a second side 56, and an outer end 57. The outer end 57 is curved. The angle of curvature between the second side 56 and the end 57 is sharper than the angle of curvature between the first side 55 and the end 57. The other end of the first caliper mounting flange 52 is integral the partial plate 51.

The second caliper mounting flange 53 has a first side 58, a second side 59, and an outer end 60. The outer edge 60 is curved. The curvature between the second side 59 and the outer edge 60 is substantially the same as the curvature between the first side 58 and the outer edge 60. The other end of the first caliper mounting flange 52 is integral the partial interior plate 51.

The partial interior plate 51 comprises a first opening 61 and a second opening 62. The first opening 61 and second opening 62 are partially separated by the caliper mounting flanges 52 and 53. The caliper mounting flanges 52 and 53 are closer to one side of the ring than the other side, making the first opening 61 smaller than the second opening 62.

The passenger front ring 32 may comprise a water drainage hole along the annular rim 47.

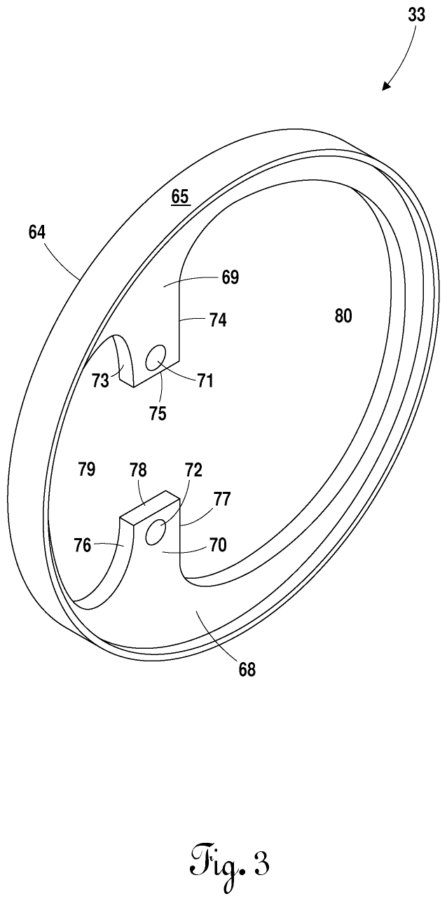

With reference to FIG. 3, the driver rear ring 33 comprises an outer annular rim 64. The annular rim 64 is circular. The outer diameter of the annular rim 64 is less than the inner diameter of a driver side rear golf cart tire. The annular rim 64 comprises an outer surface 65. A light strip 37 can be affixed to the outer surface 65 of the annular rim 64. The light strip 37 can be affixed to the outer surface 65 via an adhesive. Referring to FIG. 5, which shows a light strip 37 affixed to the outer surface of the passenger rear wheel ring 31, the light strip 37 is affixed to the driver rear ring 33 in the same manner as shown in FIG. 5 with regard to the passenger rear ring 31. In some embodiments, the light strip 37 has a peel off adhesive back that can be used to affix the light strip to the outer surface 65. In some embodiments, the annular rim 64 may comprise grooves that can be used to zip tie or otherwise tether a light strip 37 to the outer surface 65 of the annular rim 64.

The driver rear ring 33 further comprises a partial interior plate 68. The partial interior plate 68 comprises a first caliper mounting flange 69 and a second caliper mounting flange 70. The first caliper mounting flange 69 has a bolt hole 71 and the second caliper mounting flange 70 has a bolt hole 72.

The first caliper mounting flange 69 has a first side 73, a second side 74, and an outer end 75. The outer end 75 is flat. The first side 73 flares outward slightly. The second side 74 is straight. The inner end of the first caliper mounting flange 69 is integral the partial plate 68.

The second caliper mounting flange 70 has a first side 76, a second side 77, and an outer end 78. The outer end 78 is straight. The first side 76 flares outward slightly. The second side 77 is straight. The other end of the second caliper mounting flange 77 is integral the partial interior plate 68.

The partial interior plate 68 comprises a first opening 79 and a second opening 80. The first opening 79 and second opening 80 are partially separated by the caliper mounting flanges 69 and 70. The caliper mounting flanges 69 and 70 are closer to one side of the ring than the other side, making the first opening 79 smaller than the second opening 80.

The driver rear ring 33 may comprise a water drainage hole along the annular rim 64.

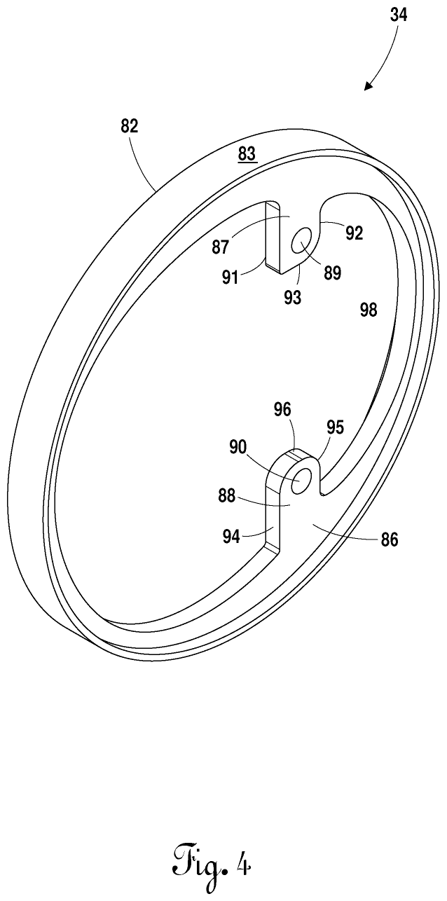

With reference to FIG. 4, the driver front ring 34 comprises an outer annular rim 82. The annular rim 82 is circular. The outer diameter of the annular rim 82 is less than the inner diameter of a driver side front golf cart tire. The annular rim 82 comprises an outer surface 83. A fourth light strip 37 can be affixed to the outer surface 83 of the annular rim 82. The light strip 37 can be affixed to the outer surface 83 via an adhesive. In some embodiments, the light strip 37 has a peel off adhesive back that can be used to affix the light strip to the outer surface 83. Referring to FIG. 5, which shows a light strip 37 affixed to the outer surface of the passenger rear wheel ring 31, the light strip 37 is affixed to the driver front ring 34 in the same manner as shown in FIG. 5 with regard to the passenger rear ring 31. In some embodiments, the annular rim 82 may comprise grooves that can be used to zip tie or otherwise tether a light strip 37 to the outer surface 83 of the annular rim 82.

The driver front ring 34 further comprises a partial interior plate 86. The partial interior plate 86 comprises a first caliper mounting flange 87 and a second caliper mounting flange 88. The first caliper mounting flange 87 has a bolt hole 89 and the second caliper mounting flange 88 has a bolt hole 90.

The first caliper mounting flange 87 has a first side 91, a second side 92, and an outer end 93. The outer end 93 is curved. The angle of curvature between the first side 91 and the end 93 is sharper than the angle of curvature between the second end 92 and the end 93. The inner end of the first caliper mounting flange 87 is integral the partial plate 86.

The second caliper mounting flange 88 has a first side 94, a second side 95, and an outer end 96. The outer end 96 is curved. The angle of curvature between the first side 94 and the end 96 is substantially the same as the angle of curvature between the second side 95 and the end 96. The other end of the second caliper mounting flange 88 is integral the partial interior plate 86.

The partial interior plate 86 comprises a first opening 97 and a second opening 98. The first opening 97 and second opening 98 are partially separated by the caliper mounting flanges 87 and 88. The caliper mounting flanges 87 and 88 are closer to one side of the ring than the other side, making the first opening 97 larger than the second opening 98.

The driver front ring 34 may comprise a water drainage along the annular rim 82.

Operation of the light caliper mounting ring system is described with reference to FIGS. 1-5. As shown in FIG. 5, a light strip 37 is attached to the surface 36 of the annual rim of the passenger rear ring 31. Alternatively individual lights instead of a light strip could be attached. The lights are affixed to the ring 31 via adhesive. In the same manner, light strips 37 are attached to the other wheel rings 32, 33, and 34.

The passenger rear ring 31 is attached to the caliper of the passenger side rear wheel of a golf cart. The rear ring 31 is specifically designed for use with a golf cart that has a caliper on the passenger rear wheel. Bolts are used to bolt the passenger rear ring 31 to the caliper on the rear passenger side of the golf cart. Those skilled in the art understand that other means of attachment could be used.

The other rings 32, 33, and 34 are similarly set up and attached. Lights are affixed to each ring, then the ring is affixed to the appropriate wheel via the caliper using bolts and the bolt holes.

The ability to bolt the rings disclosed herein to a caliper is an improvement upon existing methods and apparatus for attaching lights to golf cart wheels.

The curvature and spacing of the caliper mounting flanges and interior plates is critical to the rings functioning properly with the calipers of a golf cart.

The light strips are in electric communication with a controller, such as the controller disclosed in U.S. Pat. No. 12,156,314, the entirety of which is incorporated by reference herein. Other control mechanisms could be used to turn the light strips on and off.

Those skilled in the art understand that a power source is necessary for the lights.

1. A set of light mounting rings comprising:
a first ring, a second ring, a third ring, and a fourth ring;
the first ring comprises an annular rim with an outer surface, a partial interior plate, a first caliper mounting flange, a second caliper mounting flange, a first bolt hole, a second bolt hole, a first opening, and a second opening;
the second ring comprises an annular rim with an outer surface, a partial interior plate, a first caliper mounting flange, a second caliper mounting flange, a first bolt hole, a second bolt hole, a first opening, and a second opening;
the third ring comprises an annular rim with an outer surface, a partial interior plate, a first caliper mounting flange, a second caliper mounting flange, a first bolt hole, a second bolt hole, a first opening, and a second opening; and
the fourth ring comprises an annular rim with an outer surface, a partial interior plate, a first caliper mounting flange, a second caliper mounting flange, a first bolt hole, a second bolt hole, a first opening, and a second opening.

2. The set of light mounting rings of claim 1 wherein:
the first mounting flange of the first ring comprises a first side, a second side, and an outer end wherein the outer end is straight, the first side is straight, and the second side is flared;
the second mounting flange of the first ring comprises a first side, a second side, and an outer end wherein the outer end is straight, the first side is straight, and the second side is flared;
the first opening and the second opening of the first ring are partially separated by the first mounting flange and the second mounting flange of the first ring and the first opening is larger than the second opening;
the first mounting flange of the second ring comprises a first side, a second side, and an outer end wherein the outer end is curved and an angle of curvature between the second side and the outer end is sharper than an angle of curvature between the first side and the outer end;
the second mounting flange of the second ring comprises a first side, a second side, and an outer end wherein the outer end is curved;
the first opening and the second opening of the second ring are partially separated by the first mounting flange and the second mounting flange of the second ring and the first opening is smaller than the second opening;
the first mounting flange of the third ring comprises a first side, a second side, and an outer end wherein first side is flared, the second side is straight, and the outer end is straight;
the second mounting flange of the third ring comprises a first side, a second side, and an outer end wherein the first side is flared, the second side is straight, and the outer end is straight;
the first opening and the second opening of the third ring are partially separated by the first mounting flange and the second mounting flange of the third ring and the first opening is smaller than the second opening;
the first mounting flange of the fourth ring comprises a first side, a second side, and an outer end wherein the outer end is curved and an angle of curvature between the first side and the outer end is sharper than an angle of curvature between the second side and the outer end;
the second mounting flange of the fourth ring comprises a first side, a second side, and an outer end wherein the outer end is curved; and
the first opening and the second opening of the fourth ring are partially separated by the first mounting flange and the second mounting flange of the fourth ring and the first opening is larger than the second opening.

3. The set of light mounting rings of claim 2 further comprising:
the first ring comprises a light strip on the outer surface of the annular rim;
the second ring comprises a light strip on the outer surface of the annular rim;
the third ring comprises a light strip on the outer surface of the annular rim; and
the fourth ring comprises a light strip on the outer surface of the annular rim.

4. The set of light mounting rings of claim 3 further comprising:
the first ring is configured to mount to a caliper of a passenger side rear wheel of a golf cart;
the second ring is configured to mount to a caliper of a passenger side front wheel of the golf cart;
the third ring is configured to mount to a caliper of a driver side rear wheel of the golf cart; and
the fourth ring is configured to mount to a caliper of a driver side front wheel of the golf cart.

5. The set of light mounting rings of claim 4 further comprising:
an outer diameter of the first ring is smaller than an inner diameter of the passenger side rear wheel of the golf cart;
an outer diameter of the second ring is smaller than an inner diameter of the passenger side front wheel of the golf cart;
an outer diameter of the third ring is smaller than an inner diameter of the driver side rear wheel of the golf cart; and
an outer diameter of the fourth ring is smaller than an inner diameter of the driver side front wheel of the golf cart.
